(19) United States
(12) Patent Application Publication
(10) Pub. No.: US 2024/0420210 A1
(43) Pub. Date: Dec. 19, 2024

(54) IDENTIFYING ITEM SIMILARITY AND LIKELIHOOD OF SELECTION FOR LARGER-SIZE VARIANTS OF ITEMS ORDERED BY CUSTOMERS OF AN ONLINE CONCIERGE SYSTEM

(71) Applicant: Maplebear Inc. (dba Instacart), San Francisco, CA (US)

(72) Inventors: Bhavya Gulati, Milpitas, CA (US); Chakshu Ahuja, San Jose, CA (US); Karuna Ahuja, San Francisco, CA (US); Girija Narlikar, Palo Alto, CA (US)

(21) Appl. No.: 18/211,107

(22) Filed: Jun. 16, 2023

(51) Int. Cl. G06Q 30/0601

(52) U.S. Cl. CPC G06Q 30/0631; G06Q 30/0629

(57) ABSTRACT

An online concierge system receives information describing items in orders placed by a customer and a sequence of events associated with each order and identifies an impulse item included in the orders based on a set of rules, attributes of each item, and/or the sequence of events. The system applies a model to predict a measure of similarity between the impulse item and each of multiple candidate items and identifies larger-size variants of the impulse item based on this prediction and attributes of the impulse item and each candidate item. The system applies another model to predict a likelihood the customer will order each variant, computes a recommendation score for each variant based on this prediction, and determines whether to recommend each variant based on the score. Based on the determination, the system generates and sends a recommendation for a variant to a client device associated with the customer.

### BACKGROUND

Online concierge systems allow customers to place online delivery orders by specifying items and quantities of the items to be collected from retailer locations in shopping lists and by selecting delivery timeframes during which the orders are to be delivered. The orders are then matched with pickers who service the orders. When placing orders with online concierge systems, customers may add items that they did not plan on ordering, or “impulse items,” to their shopping lists. For example, after selecting an option to check out, a customer may be presented with a can of soda, a package of gum or candy, a small bag of chips, etc. In this example, when presented with the items, the customer may feel a sudden urge to purchase one or more of them and may add the item(s) to their shopping list prior to placing an order.

Since impulse items are usually small or single-serve items, customers who have previously purchased and enjoyed them may be more interested in larger-size versions of the impulse items, which often provide customers more value for their money. For example, if an impulse item is a small bag of potato chips priced at $0.95/ounce, customers who previously purchased the impulse item may be more interested in a larger-size bag of the same potato chips priced at $0.54/ounce. However, customers may not be aware of larger-size versions of impulse items that they previously purchased and online concierge systems may fail to notify the customers of these items since online concierge systems often recommend items to customers that the customers previously purchased. Customers who are interested in larger-size versions of impulse items may be frustrated if they learn of them only after purchasing the impulse items several times at the recommendation of online concierge systems and may refrain from using online concierge systems as a result of such negative experiences.

### SUMMARY

In accordance with one or more aspects of the disclosure, an online concierge system recommends larger-size variants of items ordered by customers of the online concierge system. More specifically, an online concierge system receives information describing one or more items included in one or more orders placed by a customer and a sequence of events included in a shopping session associated with each order. The online concierge system identifies an impulse item from the item(s) based at least in part on a set of impulse item identification rules, a set of attributes of each item, and/or the sequence of events included in each shopping session. The online concierge system then accesses a first machine learning model trained to predict a measure of similarity between two items. For each of multiple candidate items included among an inventory of a retailer associated with the online concierge system, the online concierge system applies the first model to the set of attributes of the impulse item and the set of attributes of a candidate item to predict the measure of similarity between the items. The online concierge system identifies a set of larger-size variants of the impulse item from the candidate items based at least in part on the predicted measure of similarity, one or more attributes of the impulse item, and the attribute(s) of each candidate item. The online concierge system accesses a second machine learning model trained to predict a likelihood that the customer will order an item and, for each larger-size variant, applies the second machine learning model to the set of attributes of the larger-size variant and a set of attributes of the customer to predict the likelihood that the customer will order the larger-size variant. The online concierge system also computes a recommendation score for each larger-size variant based at least in part on the predicted likelihood and determines whether to recommend the larger-size variant to the customer based at least in part on the recommendation score. The online concierge system generates a recommendation for one or more larger-size variants based at least in part on the determination and sends the recommendation for display to a client device associated with the customer.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for recommending larger-size variants of items ordered by a customer of an online concierge system, in accordance with one or more embodiments.

FIGS. 4A and 4B illustrate an example of identifying an impulse item from items included in an order placed by a customer of an online concierge system, in accordance with one or more embodiments.

FIG. 4C illustrates an example of recommending larger-size variants of items ordered by a customer of an online concierge system, in accordance with one or more embodiments.

### DETAILED DESCRIPTION

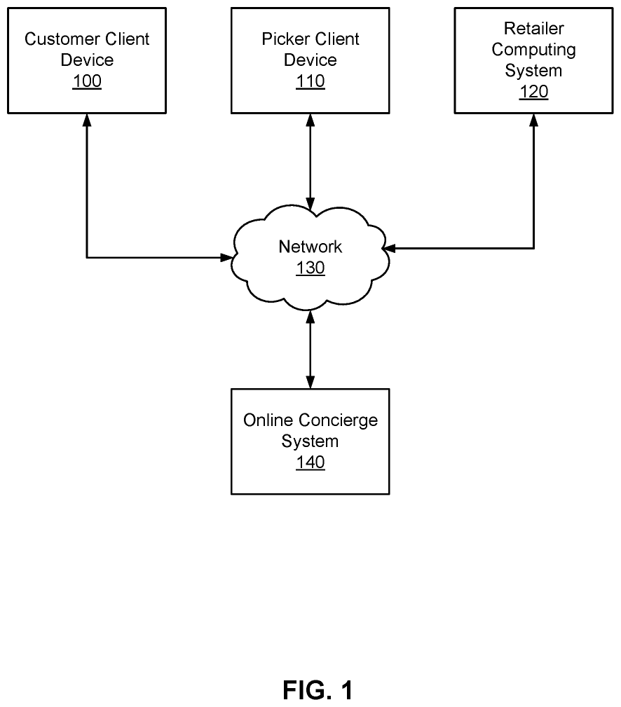

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, refers to a good or product that may be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a customer's order (e.g., as a commission).

The customer client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

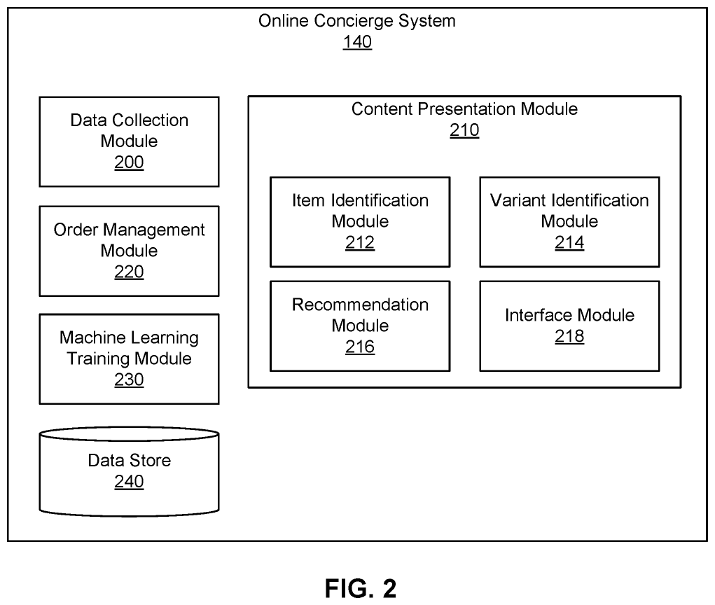

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer. As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects customer data, which is information or data that describe characteristics of a customer. Customer data may include a customer's name, address, shopping preferences, favorite items, stored payment instruments, budget (e.g., for each order or for certain item categories), dietary preferences (e.g., vegetarian, gluten-free, etc.), or demographic information (e.g., age, gender, etc.). In some embodiments, customer data also may describe characteristics of a customer's household, such as the customer's household size or information describing other members (e.g., dietary preferences, demographic information, etc.) of the customer's household. Customer data also may include information identifying a customer, such as a phone number, an email address, etc. associated with the customer. The customer data also may include default settings established by the customer, such as a default retailer/retailer location, payment instrument, delivery location, or delivery timeframe.

Customer data also may include historical information associated with a customer. For example, customer data may describe historical interaction information associated with a customer, such as a search or a browsing history of the customer, and historical order information associated with the customer, such as information describing previous orders placed by the customer (e.g., information identifying items included in the orders, prices of the items, discounts applied to the items, etc.). Customer data further may include information describing retailers (e.g., names, types, geographical locations of retailer locations operated by the retailers, etc.) and items (e.g., types, prices, etc.) with which a customer interacted (e.g., by searching for the items, clicking on them, adding them to a shopping list, etc.). Furthermore, customer data may include information associated with a customer that may be determined based on other customer data for the customer, such as a frequency with which the customer places orders or orders an item, an average number of items included in each order placed by the customer, a price sensitivity of the customer (e.g., for certain item categories), or any other suitable types of information. Customer data also may include customer satisfaction information describing a measure of satisfaction of a customer with an item as a replacement for another item included in a previous order (e.g., a rating for the replacement item). For example, if an item in a customer's order was not available at a retailer location and the item was replaced with a similar item, the customer data may include a rating provided by the customer describing their satisfaction with the replacement and a reason for the rating (e.g., the replacement was not similar enough to the item that was replaced). The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the brands, sizes, dimensions, weights, volumes, counts/quantities, colors, models/versions, stock keeping units (SKUs), serial numbers, prices, item categories, sales, discounts, qualities (e.g., freshness, ripeness, etc.), seasonality, perishability, storage methods (e.g., refrigerator, freezer, etc.), ingredients/materials, manufacturing locations, or any other suitable attributes of the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as rice, beans, and pasta may be included in a “pantry” item category. Furthermore, in various embodiments, an item may be included in multiple categories. For example, cookies may be included in a “cookies” item category, a “snack” item category, as well as a “bakery department” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, the retailers from which the picker has collected items, or the picker's previous shopping history. Additionally, the picker data may include preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data also may include information describing a shopping session associated with an order, such as a sequence of events included in the shopping session. For example, order data describing a sequence of events included in a shopping session may describe a sequence in which each item included in an order was added to a shopping list, a time at which each item included in the order was added to the shopping list, or a portion of an ordering interface (e.g., a carousel of suggested items) from which each item was added to the shopping list. In the above example, the sequence of events included in the shopping session also may describe a time at which a request to check out was received from a customer client device 100, a time at which a request to place the order was received from the customer client device 100, or any other suitable types of information. In some embodiments, order data also may include information describing a set of contextual and/or seasonal features associated with an order, such as a time of day, day of the week, one or more seasons (e.g., rainy/stormy, allergy, etc.), one or more shopping periods (e.g., back-to-school, Black Friday, etc.), one or more break periods (e.g., winter, spring, or summer), one or more holidays, etc. during which the order was placed. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. Components of the content presentation module 210 include: an item identification module 212, a variant identification module 214, a recommendation module 216, and an interface module 218, which are further described below. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. In this example, the content presentation module 210 then displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The item identification module 212 identifies impulse items from items included in previous orders placed by customers. An “impulse item,” as used herein, refers to a good or product that a customer orders without prior planning to do so. For example, a customer who has selected an option to check out may be presented with a package of gum. In this example, if the customer has a sudden urge to add the package of gum to their shopping list and does so just prior to placing an order, the item identification module 212 may identify the package of gum as an impulse item. The item identification module 212 may identify impulse items based on order data and a set of impulse item identification rules (described below) stored in the data store 240.

In some embodiments, the item identification module 212 may identify one or more impulse items included in one or more orders placed by a customer based on attributes of each item included in the order(s) and the set of impulse item identification rules. For example, the item identification module 212 may access order data including item data for one or more items included in one or more orders placed by a customer based on information identifying the customer (e.g., a username, an email address, a phone number, etc. associated with the customer) and the set of impulse item identification rules. In this example, the item identification module 212 may compare the attributes of each item included in the order(s) to the set of impulse item identification rules describing one or more attributes of an impulse item (e.g., non-perishable, less than a threshold size, belonging to a “snack” or a “soda” item category, less than a threshold cost, etc.) and identify one or more impulse items included in the order(s) based on the comparison.

In various embodiments, the item identification module 212 also or alternatively may identify one or more impulse items included in one or more orders placed by a customer based on a sequence of events included in a shopping session associated with each order and the set of impulse item identification rules. In such embodiments, the item identification module 212 may access order data including information describing a sequence of events included in a shopping session associated with each order based on information identifying the customer (e.g., a username, an email address, a phone number, etc. associated with the customer) and the set of impulse item identification rules. The item identification module 212 may then compare the information describing the sequence of events included in the shopping session to the set of impulse item identification rules (e.g., rules indicating that items are impulse items if they are added to a shopping list from a list of suggested items on a checkout page, etc.). Based on the comparison, the item identification module 212 may identify one or more impulse items included in one or more orders previously placed by the customer.

In some embodiments, the item identification module 212 also may identify bulk items from items included in previous orders placed by customers. A “bulk item,” as used herein, refers to a good or product that a retailer offers in a large quantity, size, volume, etc. For example, a soda may be offered by a retailer as a single can or bottle or as a bulk item, such as a package of six cans or six bottles of the soda. The item identification module 212 may identify one or more bulk items included in one or more orders placed by a customer based on attributes of each item included in the order(s) and a set of bulk item identification rules (described below) stored in the data store 240. For example, the item identification module 212 may access order data including item data for one or more items included in one or more orders placed by a customer based on information identifying the customer (e.g., a username, an email address, a phone number, etc. associated with the customer) and the set of bulk item identification rules. In this example, the item identification module 212 may compare one or more attributes of each item included in the order(s) to the set of bulk item identification rules describing one or more attributes of a bulk item (e.g., non-perishable, greater than a threshold size, belonging to a “snack”, “soda,” “cleaning supplies,” “personal care,” or “pantry” item category, less than a threshold unit price, etc.) and identify one or more bulk items included in the order(s) based on the comparison.

The variant identification module 214 identifies a set of larger-size variants of an impulse item. To identify the set of larger-size variants, the variant identification module 214 may predict a measure of similarity between the impulse item and each candidate item included among an inventory of a retailer associated with the online concierge system 140. The variant identification module 214 may then identify the set of larger-size variants based on the predicted measure of similarity and one or more attributes of the impulse item and each candidate item. For example, suppose that the variant identification module 214 predicts a measure of similarity between an impulse item and a candidate item, such that the impulse item has at least a threshold measure of similarity to the candidate item (e.g., they belong to the same item category, include the same ingredients, are of the same brand, etc.). In this example, if one or more attributes (e.g., size, dimension(s), volume, count, quantity, etc.) of the impulse item and the corresponding attribute(s) of the candidate item indicate that the candidate item is larger than the impulse item, the variant identification module 214 may identify the candidate item as a larger-size variant of the impulse item.

The variant identification module 214 may predict a measure of similarity between an impulse item and a candidate item in various ways. In some embodiments, the variant identification module 214 may do so by comparing one or more of their attributes (e.g., item categories, prices, storage methods, brands, ingredients/materials, etc.) and predicting the measure of similarity between them based on the comparison. For example, the variant identification module 214 may predict a measure of similarity between an impulse item and a candidate item that is proportional to a number or percentage of attributes they have in common. The variant identification module 214 also may predict a measure of similarity between an impulse item and a candidate item using an item similarity model, which is a machine learning model that is trained to predict a measure of similarity between two items. For example, the item similarity model may be trained to predict a similarity score that is proportional to a measure of similarity between two items. The item similarity model may be trained by the machine learning training module 230 based on attributes of items, customer satisfaction information, or any other suitable types of information, as described below. In some embodiments, the item similarity model uses item embeddings describing items to predict a measure of similarity between two items. These item embeddings may be generated by a machine learning model and stored in the data store 240. To use the item similarity model, the variant identification module 214 may access the model (e.g., from the data store 240) and apply the model to a set of attributes (e.g., size, brand, item category, price, colors, ingredients/materials, etc.) of an impulse item and the corresponding set of attributes of a candidate item. The variant identification module 214 may then receive an output from the item similarity model indicating a predicted measure of similarity between the impulse item and the candidate item.

In various embodiments, the variant identification module 214 may identify a set of smaller-size variants of a bulk item. To identify the set of smaller-size variants, the variant identification module 214 may predict a measure of similarity between the bulk item and each candidate item included among an inventory of a retailer associated with the online concierge system 140 in a manner analogous to that described above. The variant identification module 214 may then identify the set of smaller-size variants based on the predicted measure of similarity and one or more attributes of the bulk item and each candidate item. For example, suppose that the variant identification module 214 predicts a measure of similarity between a bulk item and a candidate item, such that the bulk item has at least a threshold measure of similarity to the candidate item (e.g., they belong to the same item category, include the same ingredients, are of the same brand, etc.). In this example, if one or more attributes (e.g., size, dimension(s), volume, count, quantity, etc.) of the bulk item and the corresponding attribute(s) of the candidate item indicate that the candidate item is smaller than the bulk item, the variant identification module 214 may identify the candidate item as a smaller-size variant of the bulk item.

The recommendation module 216 predicts likelihoods that customers will order larger-size variants of impulse items (or smaller-size variants of bulk items) identified by the variant identification module 214. The recommendation module 216 may make the predictions based on attributes of the larger-size (or smaller-size) variants and data stored in the data store 240. For example, the recommendation module 216 may predict a high likelihood that a customer will order a larger-size variant of an impulse item if customer data indicates that the customer previously ordered several larger-size variants of other items and that the customer previously ordered the impulse item several times. As an additional example, the recommendation module 216 may predict a low likelihood that a customer will order a larger-size variant of an impulse item if the larger-size variant has a higher unit price than the impulse item and customer data indicates that the customer has a small household. As yet another example, the recommendation module 216 may predict a high likelihood that a customer will order a larger-size variant of an impulse item if customer data indicates that the customer has a large household, the larger-size variant is popular among other customers with households of a similar size, and the customer places orders less frequently than most customers with households of a similar size. As another example, the recommendation module 216 may predict a high likelihood that a customer will order a smaller-size variant of a bulk item if the smaller-size variant is on sale and has a lower unit price than the bulk item, if customer data indicates that the customer has a small household, and the customer places orders more frequently than most customers with households of a similar size.

In some embodiments, the recommendation module 216 may predict a likelihood that a customer will order a larger-size variant of an impulse item (or a smaller-size variant of a bulk item) using an order prediction model, which is a machine learning model that is trained to predict a likelihood that a customer will order an item. The order prediction model may be trained by the machine learning training module 230 based on attributes of items, attributes of customers, historical order information, or any other suitable types of information, as described below. In some embodiments, the order prediction model uses item embeddings describing items and customer embeddings describing customers to predict a likelihood that a customer will order an item. These item embeddings and customer embeddings may be generated by separate machine learning models and may be stored in the data store 240. To use the order prediction model, the recommendation module 216 may access the model (e.g., from the data store 240) and apply the model to a set of attributes (e.g., household size, historical order information, price sensitivity, budget, etc.) of a customer and a set of attributes (e.g., size, brand, item category, price, colors, ingredients/materials, etc.) of a larger-size variant of an impulse item (or a smaller-size variant of a bulk item). In some embodiments, the recommendation module 216 also may apply the order prediction model to a current set of contextual and/or seasonal features. Examples of such features include: a time of day, a day of the week, one or more seasons (e.g., rainy/stormy, allergy, etc.), one or more shopping periods (e.g., back-to-school, Black Friday, etc.), one or more break periods (e.g., winter, spring, or summer), one or more holidays, etc. The recommendation module 216 may then receive an output from the order prediction model corresponding to a predicted likelihood that the customer will order the larger-size (or smaller-size) variant.

Once the recommendation module 216 predicts a likelihood that a customer will order a larger-size variant of an impulse item (or a smaller-size variant of a bulk item), the recommendation module 216 may compute a recommendation score for the larger-size (or smaller-size) variant based on the predicted likelihood. For example, the recommendation module 216 may compute a recommendation score for a larger-size (or smaller-size) variant that is proportional to the predicted likelihood that a customer will order it. In some embodiments, the recommendation module 216 also may compute a recommendation score for a larger-size (or smaller-size) variant based on additional types of information. Examples of such information include: information identifying items in a shopping list associated with a customer, a predicted availability of the larger-size (or smaller-size) variant at one or more retailer locations, a measure of similarity between the larger-size variant and the impulse item (or between the smaller-size variant and the bulk item), a value associated with the larger-size (or smaller-size) variant, a search query received from a customer client device 100 associated with the customer, etc. For example, the recommendation module 216 may compute a high recommendation score for a larger-size variant if the larger-size variant or a similar item is not already in a shopping list associated with a customer and if a predicted availability of the larger-size variant at a retailer location at which it is to be collected is at least a threshold predicted availability. Alternatively, in the above example, the recommendation module 216 may compute a low recommendation score for the larger-size variant if the larger-size variant or a similar item is already in the shopping list or if the predicted availability of the larger-size variant at the retailer location is less than the threshold predicted availability. As an additional example, a recommendation score for a larger-size variant of an impulse item computed by the recommendation module 216 may be proportional to a measure of similarity between the larger-size variant and the impulse item and a price of the larger-size variant. As yet another example, the recommendation module 216 may compute a low recommendation score for a larger-size variant if a search query received from a customer client device 100 associated with the customer includes a brand that does not match a brand of the larger-size variant.

The recommendation module 216 determines whether to recommend larger-size variants of impulse items (or smaller-size variants of bulk items) to customers based on the recommendation scores for the larger-size (or smaller-size) variants. In some embodiments, the recommendation module 216 may do so by comparing a recommendation score for a larger-size (or smaller-size) variant to a threshold score and determining that the larger-size (or smaller-size) variant should be recommended to a customer if the recommendation score is at least the threshold score. In such embodiments, the recommendation module 216 alternatively may determine that the larger-size (or smaller-size) variant should not be recommended to the customer if the recommendation score is less than the threshold score.

In embodiments in which the recommendation module 216 computes recommendation scores for multiple larger-size (or smaller-size) variants, the recommendation module 216 may rank the larger-size (or smaller-size) variants based on their corresponding recommendation scores and determine whether to recommend one or more larger-size (or smaller-size) variants to a customer based on the ranking. For example, the recommendation module 216 may rank larger-size variants based on their recommendation scores, from highest to lowest, and determine that larger-size variants with recommendation scores that exceed some threshold (e.g., the top n larger-size variants or the p percentile of larger-size variants) should be recommended to a customer.

In various embodiments, the recommendation module 216 also may rank larger-size (or smaller-size) variants among other types of objects, such as other items, content items, etc. in a unified ranking based on the recommendation scores for the variants and values associated with the objects and determine whether to recommend one or more larger-size (or smaller-size) variants and/or objects to a customer based on the ranking. For example, the recommendation module 216 may rank larger-size variants among other items and content items (e.g., advertisements, coupons, promotions, recipes, etc.) in a unified ranking based on the recommendation score associated with each larger-size variant and an expected value associated with each item/content item. In this example, the expected value associated with each item/content item may be computed as a product of an interaction probability for a customer with the item/content item and a bid amount, price, etc. associated with the item/content item. Continuing with this example, the recommendation module 216 may determine whether to recommend a set of the larger-size variants, items, and/or content items to the customer based on the ranking.

The interface module 218 generates recommendations for larger-size variants of impulse items (or smaller-size variants of bulk items). The interface module 218 may do so based on the determination made by the recommendation module 216 as to whether to recommend the larger-size (or smaller-size) variants to customers. For example, if the recommendation module 216 determines that one or more larger-size variants of an impulse item should be recommended to a customer, the interface module 218 may generate a recommendation for the larger-size variant(s). A recommendation generated by the interface module 218 may be for one or more larger-size (or smaller-size) variants presented in a display unit (e.g., a pop-up window, a carousel, etc.) and may indicate a reason for the recommendation (e.g., based on a previous purchase of an impulse item or a bulk item). A recommendation may include a unit price associated with each larger-size (or smaller-size) variant. A recommendation may also include a unit price associated with an impulse item (or a bulk item). Furthermore, a recommendation may call attention to one or more unit prices. For example, a recommendation may include a unit price (e.g., price per oz., lb., etc.) of an impulse item and each larger-size variant, in which the unit price associated with each larger-size variant is highlighted in the recommendation. In some embodiments, a recommendation for a customer also may include additional types of information, such as a recipe that uses a larger-size (or smaller-size) variant included in the recommendation, a suggestion to share or split the larger-size (or smaller-size) variant with another customer to whom the customer is connected (e.g., via the online concierge system 140 or a social networking system) who often orders the larger-size (or smaller-size) variant, etc.

Once the interface module 218 generates a recommendation for one or more larger-size (or smaller-size) variants, the interface module 218 may send the recommendation for display to a customer client device 100. A recommendation may be presented in a portion of an ordering interface, in an email, as a push notification, etc. For example, a recommendation may be presented in a portion of a checkout page of an ordering interface below a shopping list.

The order management module 220 manages orders for items from customers. The order management module 220 receives orders from customer client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit instructions to the picker client device 110 to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the variant identification module 214 accesses the item similarity model that is trained to predict a measure of similarity between two items, the machine learning training module 230 may train the item similarity model. The machine learning training module 230 may train the item similarity model via supervised learning based on attributes of various items, customer satisfaction information, or any other suitable types of information. As described above, attributes of items may include brands, sizes, dimensions, weights, volumes, counts/quantities, colors, models/versions, SKUs, serial numbers, prices, item categories, sales, discounts, qualities (e.g., freshness, ripeness, etc.), seasonality, perishability, storage methods (e.g., refrigerator, freezer, etc.), ingredients/materials, manufacturing locations, or any other suitable attributes of the items. As also described above, customer satisfaction information describes a measure of satisfaction of a customer with an item as a replacement for another item included in a previous order, such as a rating for the replacement item and a reason for the rating (e.g., the replacement was not similar enough to the item that was replaced, etc.). To illustrate an example of how the item similarity model may be trained, suppose that the machine learning training module 230 receives a set of training examples. In this example, the set of training examples may include attributes of pairs of items, such as item categories, qualities, ingredients, materials, etc. associated with the pairs of items. In the above example, the machine learning training module 230 also may receive labels which represent expected outputs of the item similarity model, in which a label indicates a measure of similarity between a pair of items (e.g., based on a measure of satisfaction of a customer with one of the items as a replacement for the other item). Continuing with this example, the machine learning training module 230 may then train the item similarity model based on the attributes as well as the labels by comparing its output from input data of each training example to the label for the training example.

In embodiments in which the recommendation module 216 accesses the order prediction model that is trained to predict a likelihood that a customer will order an item, the machine learning training module 230 may train the order prediction model. The machine learning training module 230 may train the order prediction model via supervised learning based on attributes of items and customers, as well as historical order information, or any other suitable types of information. To illustrate an example of how the order prediction model may be trained, suppose that the machine learning training module 230 receives a set of training examples. In this example, the set of training examples may include attributes of items presented to customers (e.g., sizes, colors, prices, item categories, brands, sales, discounts, qualities, ingredients, materials, manufacturing locations, etc. associated with the items). In this example, the set of training examples also may include attributes of customers presented with the items (e.g., names, geographical locations, favorite items, dietary preferences, etc. associated with the customers). In the above example, the set of training examples also may include contextual and/or seasonal features (e.g., a time of day, a day of the week, one or more seasons, one or more shopping periods, one or more break periods, one or more holidays, etc.) during which the items were presented to the customers. In this example, the machine learning training module 230 also may receive labels which represent expected outputs of the order prediction model, in which a label indicates whether a customer ordered an item. Continuing with this example, the machine learning training module 230 may then train the order prediction model based on the attributes and features, as well as the labels by comparing its output from input data of each training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. As an additional example, the data store 240 stores content items including advertisements, coupons, promotions, recipes, images (e.g., photographs), videos, etc. for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The data store 240 also stores a set of impulse item identification rules used by the online concierge system 140 to identify impulse items included in orders. In some embodiments, the set of impulse item identification rules may describe one or more attributes of impulse items, such as a perishability of an impulse item, a size, one or more dimensions, a volume, a count, a quantity, etc. of an impulse item, one or more item categories to which an impulse item belongs, a cost of an impulse item, or any other suitable attributes of an impulse item. For example, the set of impulse item identification rules may indicate that an item included in an order is an impulse item if it is a non-perishable single-serve item (e.g., less than a threshold size), belongs to a “snack” or “soda” item category, and costs less than a certain amount (e.g., $5.00). In various embodiments, the set of impulse item identification rules also or alternatively may identify an impulse item based on a sequence of events included in a shopping session associated with an order that includes the impulse item. A sequence of events included in a shopping session may describe a time at which each item was added to a shopping list, a time at which a request to check out for an order was received from a customer client device 100, a time at which a request to place an order was received from a customer client device 100, a portion of an ordering interface from which an item was added to a shopping list, a sequence in which items were added to a shopping list, etc. For example, the set of impulse item identification rules may indicate that an item included in an order is an impulse item if it was added to a shopping list from a carousel of suggested items on a checkout page, if it was added to the shopping list from a list of suggested items while browsing items that were not included in a list of search results, etc. As an additional example, the set of impulse item identification rules may indicate that an item included in an order is not an impulse item if a name or a description of the item was included in a search query and the item was subsequently added to a shopping list from a list of returned search results.

The data store 240 also may store a set of bulk item identification rules used by the online concierge system 140 to identify bulk items included in orders. In some embodiments, the set of bulk item identification rules may describe one or more attributes of bulk items, such as a size, one or more dimensions, a volume, a count, a quantity, etc. of a bulk item, a perishability of a bulk item, one or more item categories to which a bulk item belongs, a cost of a bulk item, or any other suitable attributes of a bulk item. For example, the set of bulk item identification rules may indicate that an item included in an order is a bulk item if it is non-perishable, greater than a threshold size, belongs to a “snack,” “soda,” “cleaning supplies,” “personal care,” or “pantry” item category, and costs more than a certain amount (e.g., $5.00).

### Recommending Larger-Size Variants of Items Ordered by a Customer of an Online Concierge System

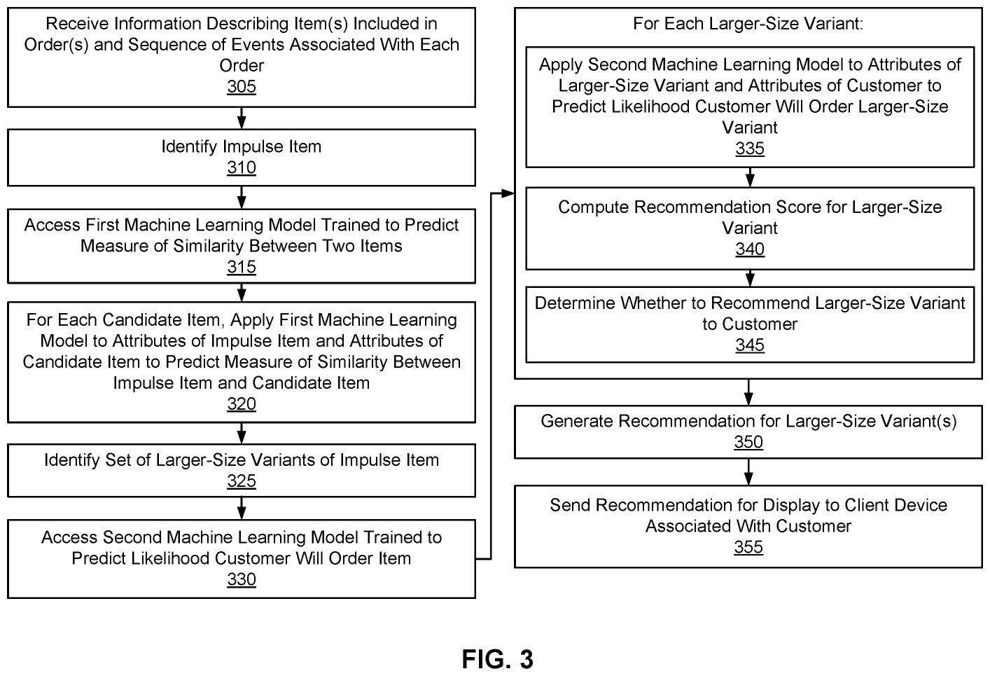

FIG. 3 is a flowchart of a method for recommending larger-size variants of items ordered by a customer of an online concierge system 140, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

The online concierge system 140 receives 305 (e.g., via the data collection module 200) information describing one or more items included in one or more orders placed by a customer of the online concierge system 140 and a sequence of events included in a shopping session associated with each order. For example, the online concierge system 140 may receive 305 information included among customer data or order data (e.g., stored in the data store 240) describing previous orders placed by the customer (e.g., information identifying items included in the orders, prices of the items, discounts applied to the items, etc.) and information describing a sequence of events included in a shopping session associated with each order. In this example, the sequence of events included in the shopping session may describe a sequence in which each item included in an order was added to a shopping list, a time at which each item included in the order was added to the shopping list, or a portion of an ordering interface (e.g., a carousel of suggested items) from which each item was added to the shopping list. In the above example, the sequence of events included in the shopping session also may describe a time at which a request to check out was received 305 from a customer client device 100, a time at which a request to place the order was received 305 from the customer client device 100, or any other suitable types of information. In some embodiments, the information received 305 by the online concierge system 140 also may describe a set of contextual and/or seasonal features associated with an order placed by the customer, such as a time of day, day of the week, one or more seasons (e.g., rainy/stormy, allergy, etc.), one or more shopping periods (e.g., back-to-school, Black Friday, etc.), one or more break periods (e.g., winter, spring, or summer), one or more holidays, etc. during which the order was placed.

The online concierge system 140 then identifies 310 (e.g., using the item identification module 212) an impulse item from the item(s) included in the order(s) placed by the customer. The online concierge system 140 may identify 310 the impulse item based on order data for the order(s) placed by the customer and a set of impulse item identification rules (e.g., stored in the data store 240). In some embodiments, the set of impulse item identification rules may describe one or more attributes of impulse items, such as a perishability of an impulse item, a size, one or more dimensions, a volume, a count, a quantity, etc. of an impulse item, one or more item categories to which an impulse item belongs, a cost of an impulse item, or any other suitable attributes of an impulse item. For example, the set of impulse item identification rules may indicate that an item included in an order is an impulse item if it is a non-perishable single-serve item (e.g., less than a threshold size), belongs to a “snack” or “soda” item category, and costs less than a certain amount (e.g., $5.00). In various embodiments, the set of impulse item identification rules also or alternatively may identify an impulse item based on a sequence of events included in a shopping session associated with an order that includes the impulse item. A sequence of events included in a shopping session may describe a time at which each item was added to a shopping list, a time at which a request to check out for an order was received 305 from a customer client device 100, a time at which a request to place an order was received 305 from a customer client device 100, a portion of an ordering interface from which an item was added to a shopping list, a sequence in which items were added to a shopping list, etc. For example, the set of impulse item identification rules may indicate that an item included in an order is an impulse item if it was added to a shopping list from a carousel of suggested items on a checkout page, if it was added to the shopping list from a list of suggested items while browsing items that were not included in a list of search results, etc. As an additional example, the set of impulse item identification rules may indicate that an item included in an order is not an impulse item if a name or a description of the item was included in a search query and the item was subsequently added to a shopping list from a list of returned search results.

In some embodiments, the online concierge system 140 may identify 310 the impulse item based on attributes of each item included in the order(s) and the set of impulse item identification rules. For example, the online concierge system 140 may access order data including item data for the item(s) included in the order(s) placed by the customer based on information identifying the customer (e.g., a username, an email address, a phone number, etc. associated with the customer) and the set of impulse item identification rules. In this example, the online concierge system 140 may compare the attributes of each item included in the order(s) to the set of impulse item identification rules describing one or more attributes of an impulse item (e.g., non-perishable, less than a threshold size, belonging to a “snack” or a “soda” item category, less than a threshold cost, etc.) and identify 310 the impulse item included in the order(s) based on the comparison.

In various embodiments, the online concierge system 140 also or alternatively may identify 310 the impulse item included in the order(s) placed by the customer based on the sequence of events included in a shopping session associated with each order and the set of impulse item identification rules. In such embodiments, the online concierge system 140 may access order data including information describing a sequence of events included in a shopping session associated with each order based on information identifying the customer (e.g., a username, an email address, a phone number, etc. associated with the customer) and the set of impulse item identification rules. The online concierge system 140 may then compare the information describing the sequence of events included in the shopping session to the set of impulse item identification rules (e.g., rules indicating that items are impulse items if they are added to a shopping list from a list of suggested items on a checkout page, etc.). Based on the comparison, the online concierge system 140 may identify 310 the impulse item included in the order(s) previously placed by the customer.

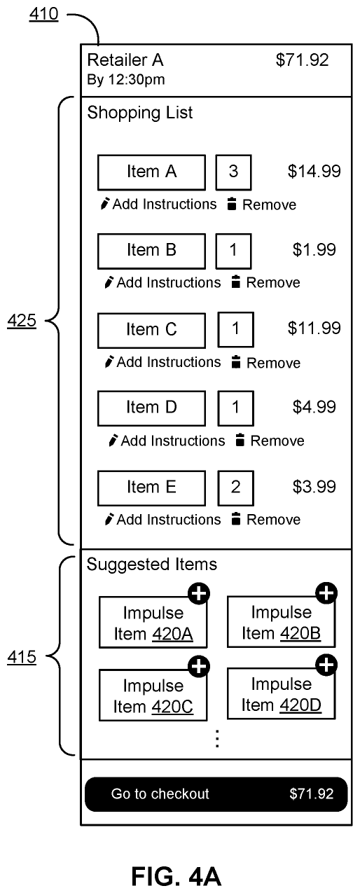

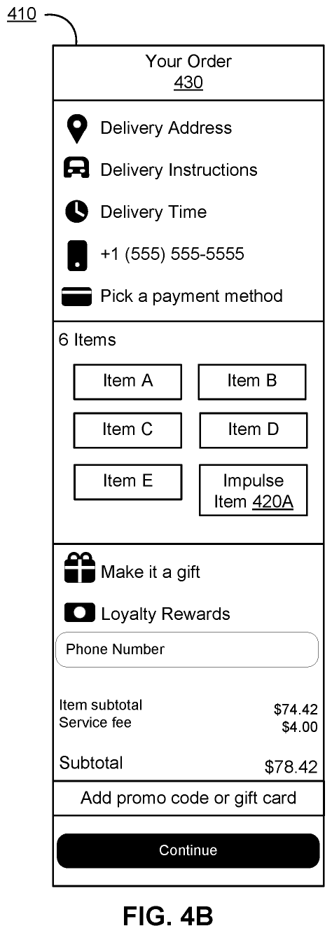

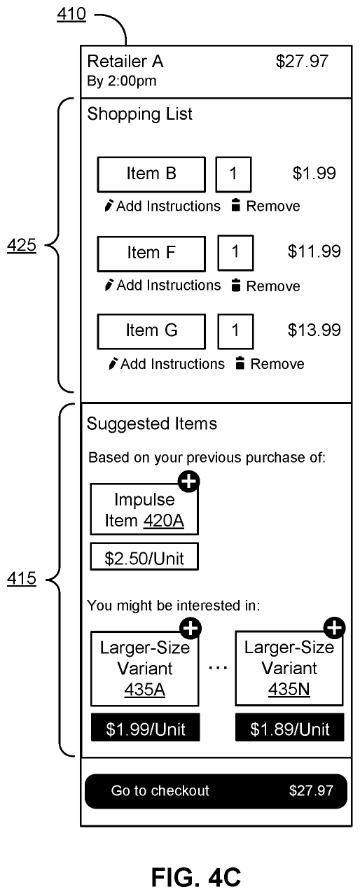

FIGS. 4A and 4B illustrate an example of identifying an impulse item 420 from items included in an order 430 placed by a customer of an online concierge system 140, in accordance with one or more embodiments. Referring first to FIG. 4A, suppose that from a checkout page of an ordering interface 410, the customer adds impulse item 420A from a list of suggested items 415 to other items included in their shopping list 425. In this example, suppose also that the customer subsequently places an order 430 including impulse item 420A, as shown in FIG. 4B. Continuing with this example, since impulse item 420A was added to the shopping list 425 from the list of suggested items 415 presented on the checkout page, if the set of impulse item identification rules indicates that items are impulse items 420 if they are added to a shopping list 425 from a list of suggested items 415 on a checkout page, the online concierge system 140 may identify 310 impulse item 420A as an impulse item 420.

In some embodiments, the online concierge system 140 also may identify (e.g., using the item identification module 212) a bulk item from the item(s) included in the order(s) 430 placed by the customer. The online concierge system 140 may identify the bulk item based on attributes of each item included in the order(s) 430 and a set of bulk item identification rules (e.g., stored in the data store 240). In some embodiments, the set of bulk item identification rules may describe one or more attributes of bulk items, such as a size, one or more dimensions, a volume, a count, a quantity, etc. of a bulk item, a perishability of a bulk item, one or more item categories to which a bulk item belongs, a cost of a bulk item, or any other suitable attributes of a bulk item. For example, the set of bulk item identification rules may indicate that an item included in an order 430 is a bulk item if it is non-perishable, greater than a threshold size, belongs to a “snack,” “soda,” “cleaning supplies,” “personal care,” or “pantry” item category, and costs more than a certain amount (e.g., $5.00). To identify the bulk item, the online concierge system 140 may compare the attributes of each item included in the order(s) 430 to the set of bulk item identification rules and identify the bulk item based on the comparison. For example, the online concierge system 140 may access order data including item data for the item(s) included in the order(s) 430 placed by the customer based on information identifying the customer (e.g., a username, an email address, a phone number, etc. associated with the customer) and the set of bulk item identification rules. In this example, the online concierge system 140 may compare one or more attributes of each item included in the order(s) 430 to the set of bulk item identification rules describing one or more attributes of a bulk item (e.g., non-perishable, greater than a threshold size, belonging to a “snack”, “soda,” “cleaning supplies,” “personal care,” or “pantry” item category, less than a threshold unit price, etc.) and identify a bulk item included in the order(s) 430 based on the comparison.

Referring again to FIG. 3, the online concierge system 140 then predicts (e.g., using the variant identification module 214) a measure of similarity between the impulse item 420 and each candidate item included among an inventory of a retailer associated with the online concierge system 140. In some embodiments, the online concierge system 140 may do so by comparing one or more attributes (e.g., item categories, prices, storage methods, brands, ingredients/materials, etc.) of the impulse item 420 and each candidate item and predicting the measure of similarity between them based on the comparison. For example, the online concierge system 140 may predict a measure of similarity between the impulse item 420 and a candidate item that is proportional to a number or percentage of attributes they have in common.

The online concierge system 140 also may predict the measure of similarity between the impulse item 420 and a candidate item using an item similarity model, which is a machine learning model that is trained to predict a measure of similarity between two items. For example, the item similarity model may be trained to predict a similarity score that is proportional to a measure of similarity between two items. The item similarity model may be trained by the online concierge system 140 (e.g., using the machine learning training module 230) based on attributes of items, customer satisfaction information, or any other suitable types of information. In some embodiments, the item similarity model uses item embeddings describing items to predict a measure of similarity between two items. These item embeddings may be generated by a machine learning model and stored (e.g., in the data store 240). To use the item similarity model, the online concierge system 140 accesses 315 (e.g., using the variant identification module 214) the model (e.g., from the data store 240). For each candidate item, the online concierge system 140 then applies 320 (e.g., using the variant identification module 214) the model to a set of attributes (e.g., size, brand, item category, price, colors, ingredients/materials, etc.) of the impulse item 420 and the corresponding set of attributes of the candidate item. The online concierge system 140 then receives an output from the item similarity model indicating a predicted measure of similarity between the impulse item 420 and the candidate item.

The online concierge system 140 then identifies 325 (e.g., using the variant identification module 214) a set of larger-size variants of the impulse item 420 based on the predicted measure of similarity and one or more attributes of the impulse item 420 and each candidate item. For example, suppose that the online concierge system 140 predicts a measure of similarity between the impulse item 420 and a candidate item, such that the impulse item 420 has at least a threshold measure of similarity to the candidate item (e.g., they belong to the same item category, include the same ingredients, are of the same brand, etc.). In this example, if one or more attributes (e.g., size, dimension(s), volume, count, quantity, etc.) of the impulse item 420 and the corresponding attribute(s) of the candidate item indicate that the candidate item is larger than the impulse item 420, the online concierge system 140 may identify 325 the candidate item as a larger-size variant of the impulse item 420.

In embodiments in which the online concierge system 140 identifies a bulk item from the item(s) included in the order(s) 430 placed by the customer, the online concierge system 140 may identify (e.g., using the variant identification module 214) a set of smaller-size variants of the bulk item. To identify the set of smaller-size variants, the online concierge system 140 may predict a measure of similarity between the bulk item and each candidate item included among the inventory of the retailer associated with the online concierge system 140 in a manner analogous to that described above. The online concierge system 140 may then identify the set of smaller-size variants based on the predicted measure of similarity and one or more attributes of the bulk item and each candidate item. For example, suppose that the online concierge system 140 predicts a measure of similarity between the bulk item and a candidate item, such that the bulk item has at least a threshold measure of similarity to the candidate item (e.g., they belong to the same item category, include the same ingredients, are of the same brand, etc.). In this example, if one or more attributes (e.g., size, dimension(s), volume, count, quantity, etc.) of the bulk item and the corresponding attribute(s) of the candidate item indicate that the candidate item is smaller than the bulk item, the online concierge system 140 may identify the candidate item as a smaller-size variant of the bulk item.

The online concierge system 140 then predicts (e.g., using the recommendation module 216) a likelihood that the customer will order each larger-size variant of the impulse item 420 (or each smaller-size variant of the bulk item) identified 325 by the online concierge system 140. The online concierge system 140 may make the prediction based on attributes of the larger-size (or smaller-size) variant and data stored in the online concierge system 140 (e.g., in the data store 240). For example, the online concierge system 140 may predict a high likelihood that the customer will order a larger-size variant of the impulse item 420 if customer data indicates that the customer previously ordered several larger-size variants of other items and that the customer previously ordered the impulse item 420 several times. As an additional example, the online concierge system 140 may predict a low likelihood that the customer will order a larger-size variant of the impulse item 420 if the larger-size variant has a higher unit price than the impulse item 420 and customer data indicates that the customer has a small household. As yet another example, the online concierge system 140 may predict a high likelihood that the customer will order a larger-size variant of the impulse item 420 if customer data indicates that the customer has a large household, the larger-size variant is popular among other customers with households of a similar size, and the customer places orders 430 less frequently than most customers with households of a similar size. As another example, the online concierge system 140 may predict a high likelihood that the customer will order a smaller-size variant of the bulk item if the smaller-size variant is on sale and has a lower unit price than the bulk item, if customer data indicates that the customer has a small household, and the customer places orders 430 more frequently than most customers with households of a similar size.

In some embodiments, the online concierge system 140 may predict the likelihood that the customer will order a larger-size variant of the impulse item 420 (or a smaller-size variant of the bulk item) using an order prediction model, which is a machine learning model that is trained to predict a likelihood that a customer will order an item. The order prediction model may be trained by the online concierge system 140 (e.g., using the machine learning training module 230) based on attributes of items, attributes of customers, historical order information, or any other suitable types of information. In some embodiments, the order prediction model uses item embeddings describing items and customer embeddings describing customers to predict a likelihood that a customer will order an item. These item embeddings and customer embeddings may be generated by separate machine learning models and may be stored (e.g., in the data store 240). To use the order prediction model, the online concierge system 140 accesses 330 (e.g., using the recommendation module 216) the model (e.g., from the data store 240). Then, for each larger-size (or smaller-size) variant identified 325 by the online concierge system 140, the online concierge system 140 applies 335 (e.g., using the recommendation module 216) the model to a set of attributes (e.g., household size, historical order information, price sensitivity, budget, etc.) of the customer and a set of attributes (e.g., size, brand, item category, price, colors, ingredients/materials, etc.) of the larger-size (or smaller-size) variant. In some embodiments, the online concierge system 140 also may apply 335 the order prediction model to a current set of contextual and/or seasonal features. Examples of such features include: a time of day, a day of the week, one or more seasons (e.g., rainy/stormy, allergy, etc.), one or more shopping periods (e.g., back-to-school, Black Friday, etc.), one or more break periods (e.g., winter, spring, or summer), one or more holidays, etc. The online concierge system 140 then receives an output from the order prediction model corresponding to a predicted likelihood that the customer will order the larger-size (or smaller-size) variant.

Once the online concierge system 140 predicts the likelihood that the customer will order a larger-size variant of the impulse item 420 (or a smaller-size variant of the bulk item), the online concierge system 140 may compute 340 (e.g., using the recommendation module 216) a recommendation score for the larger-size (or smaller-size) variant based on the predicted likelihood. For example, the online concierge system 140 may compute 340 a recommendation score for a larger-size (or smaller-size) variant that is proportional to the predicted likelihood that the customer will order it. In some embodiments, the online concierge system 140 also may compute 340 a recommendation score for a larger-size (or smaller-size) variant based on additional types of information. Examples of such information include: information identifying items in the shopping list 425 associated with the customer, a predicted availability of the larger-size (or smaller-size) variant at one or more retailer locations operated by the retailer, a measure of similarity between the larger-size variant and the impulse item 420 (or between the smaller-size variant and the bulk item), a value associated with the larger-size (or smaller-size) variant, a search query received from a customer client device 100 associated with the customer, etc. For example, the online concierge system 140 may compute 340 a high recommendation score for a larger-size variant if the larger-size variant or a similar item is not already in the shopping list 425 associated with the customer and if a predicted availability of the larger-size variant at a retailer location at which it is to be collected is at least a threshold predicted availability. Alternatively, in the above example, the online concierge system 140 may compute 340 a low recommendation score for the larger-size variant if the larger-size variant or a similar item is already in the shopping list 425 or if the predicted availability of the larger-size variant at the retailer location is less than the threshold predicted availability. As an additional example, a recommendation score for the larger-size variant computed 340 by the online concierge system 140 may be proportional to a measure of similarity between the larger-size variant and the impulse item 420 and a price of the larger-size variant. As yet another example, the online concierge system 140 may compute 340 a low recommendation score for a larger-size variant if a search query received from a customer client device 100 associated with the customer includes a brand that does not match a brand of the larger-size variant.

The online concierge system 140 then determines 345 (e.g., using the recommendation module 216) whether to recommend each larger-size variant of the impulse item 420 (or each smaller-size variant of the bulk item) to the customer based on the recommendation score for each larger-size (or smaller-size) variant. In some embodiments, the online concierge system 140 may do so by comparing a recommendation score for a larger-size (or smaller-size) variant to a threshold score and determining 345 that the larger-size (or smaller-size) variant should be recommended to the customer if the recommendation score is at least the threshold score. In such embodiments, the online concierge system 140 alternatively may determine 345 that the larger-size (or smaller-size) variant should not be recommended to the customer if the recommendation score is less than the threshold score.

In embodiments in which the online concierge system 140 computes (step 340) recommendation scores for multiple larger-size (or smaller-size) variants, the online concierge system 140 may rank (e.g., using the recommendation module 216) the larger-size (or smaller-size) variants based on their corresponding recommendation scores and determine 345 whether to recommend one or more larger-size (or smaller-size) variants to the customer based on the ranking. For example, the online concierge system 140 may rank larger-size variants based on their recommendation scores, from highest to lowest, and determine 345 that larger-size variants with recommendation scores that exceed some threshold (e.g., the top n larger-size variants or the p percentile of larger-size variants) should be recommended to the customer.

In various embodiments, the online concierge system 140 also may rank larger-size (or smaller-size) variants among other types of objects, such as other items, content items, etc. in a unified ranking based on the recommendation scores for the variants and values associated with the objects and determine 345 whether to recommend one or more larger-size (or smaller-size) variants and/or objects to the customer based on the ranking. For example, the online concierge system 140 may rank larger-size variants among other items and content items (e.g., advertisements, coupons, promotions, recipes, etc.) in a unified ranking based on the recommendation score associated with each larger-size variant and an expected value associated with each item/content item. In this example, the expected value associated with each item/content item may be computed as a product of an interaction probability for the customer with the item/content item and a bid amount, price, etc. associated with the item/content item. Continuing with this example, the online concierge system 140 may determine 345 whether to recommend a set of the larger-size variants, items, and/or content items to the customer based on the ranking.

The online concierge system 140 then generates 350 (e.g., using the interface module 218) a recommendation for one or more larger-size variants of the impulse item 420 (or smaller-size variants of the bulk item). The online concierge system 140 may do so based on the determination made by the online concierge system 140 as to whether to recommend the larger-size (or smaller-size) variant(s) to the customer. For example, if the online concierge system 140 determines 345 that one or more larger-size variants of the impulse item 420 should be recommended to the customer, the online concierge system 140 may generate 350 the recommendation for the larger-size variant(s). The recommendation generated 350 by the online concierge system 140 may be for one or more larger-size (or smaller-size) variants presented in a display unit (e.g., a pop-up window, a carousel, etc.) and may indicate a reason for the recommendation (e.g., based on a previous purchase of the impulse item 420 or the bulk item). FIG. 4C illustrates an example of recommending larger-size variants 435 of items ordered by a customer of an online concierge system 140, in accordance with one or more embodiments and continues the example described above in conjunction with FIGS. 4A and 4B. As shown in the example of FIG. 4C, a portion of the checkout page of the ordering interface 410 that includes a list of suggested items 415 may indicate that larger-size variants 435A-N included in this portion are being recommended to the customer based on their previous purchase of impulse item 420A. The recommendation may include a unit price associated with each larger-size (or smaller-size) variant 435. The recommendation may also include a unit price associated with the impulse item 420 (or the bulk item). Furthermore, the recommendation may call attention to one or more unit prices. As shown in FIG. 4C, the recommendation may include a unit price (e.g., price per oz., lb., etc.) of impulse item 420A and each larger-size variant 435A-N, in which the unit price associated with each larger-size variant 435A-N is highlighted. In some embodiments, the recommendation for the customer also may include additional types of information, such as a recipe that uses a larger-size (or smaller-size) variant 435 included in the recommendation, a suggestion to share or split the larger-size (or smaller-size) variant 435 with another customer to whom the customer is connected (e.g., via the online concierge system 140 or a social networking system) who often orders the larger-size (or smaller-size) variant 435, etc.

Referring once more to FIG. 3, once generated 350, the recommendation may be sent 355 (e.g., via the interface module 218) for display to a customer client device 100 associated with the customer. The recommendation may be presented in a portion of the ordering interface 410, in an email, as a push notification, etc. For example, as shown in FIG. 4C, the recommendation may be presented in a portion of the checkout page of the ordering interface 410 below the shopping list 425.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online concierge system, information describing one or more items included in one or more orders placed by a customer of the online concierge system and a sequence of events included in a shopping session associated with each order of the one or more orders;
identifying an impulse item from the one or more items based at least in part on one or more of: a set of impulse item identification rules, a set of item attributes of each item of the one or more items, or the sequence of events included in the shopping session associated with each order of the one or more orders;
accessing a first machine learning model trained to predict a measure of similarity between two items;
for each candidate item of a plurality of candidate items included among an inventory of a retailer associated with the online concierge system, applying the first machine learning model to the set of item attributes of the impulse item and the set of item attributes of a corresponding candidate item to predict the measure of similarity between the impulse item and the corresponding candidate item;
identifying, from the plurality of candidate items, a set of larger-size variants of the impulse item based at least in part on the predicted measure of similarity between the impulse item and each candidate item of the plurality of candidate items, one or more item attributes of the impulse item, and the one or more item attributes of each candidate item;
accessing a second machine learning model trained to predict a likelihood that the customer will order an item;
for each larger-size variant of the set of larger-size variants:
applying the second machine learning model to the set of item attributes of a corresponding larger-size variant and a set of customer attributes of the customer to predict the likelihood that the customer will order the corresponding larger-size variant,
computing a recommendation score for the corresponding larger-size variant based at least in part on the predicted likelihood that the customer will order the corresponding larger-size variant, and
determining whether to recommend the corresponding larger-size variant to the customer based at least in part on the recommendation score for the corresponding larger-size variant;
generating a recommendation for one or more larger-size variants based at least in part on the determining; and
sending the recommendation for display to a client device associated with the customer.

2. The method of claim 1, wherein the sequence of events included in the shopping session associated with each order of the one or more orders describes one or more of: a time at which each of the one or more items was added to a shopping list, a time at which a request to check out for each of the one or more orders was received from a client device associated with the customer, a time at which a request to place each of the one or more orders was received from a client device associated with the customer, a portion of an ordering interface from which each of the one or more items was added to a shopping list, or a sequence in which the one or more items were added to a shopping list.

3. The method of claim 1, wherein the set of item attributes comprises one or more of: a size of an item, one or more dimensions of an item, a volume of an item, a count associated with an item, a quantity of an item, one or more colors of an item, a weight of an item, a SKU of an item, a serial number of an item, a model of an item, a version of an item, a perishability of an item, a storage method associated with an item, a price of an item, an item category associated with an item, a brand of an item, a seasonality associated with an item, a sale associated with an item, a discount associated with an item, one or more qualities associated with an item, one or more ingredients of an item, one or more materials of an item, or one or more manufacturing locations for an item.

4. The method of claim 1, wherein the recommendation for the one or more larger-size variants comprises a unit price associated with each larger-size variant of the one or more larger-size variants and a unit price of the impulse item, and wherein the recommendation for the one or more larger-size variants calls attention to the unit price associated with each larger-size variant of the one or more larger-size variants.

5. The method of claim 1, wherein the measure of similarity between the impulse item and the corresponding candidate item is predicted based at least in part on a set of item embeddings.

6. The method of claim 1, wherein computing the recommendation score for the corresponding larger-size variant is further based at least in part on a value associated with the corresponding larger-size variant.

7. The method of claim 1, wherein applying the second machine learning model further comprises:
applying the second machine learning model to a current set of contextual and seasonal features, wherein the current set of contextual and seasonal features comprises one or more of: a time of day, a day of a week, one or more seasons, one or more shopping periods, or one or more holidays.

8. The method of claim 1, wherein computing the recommendation score for the corresponding larger-size variant is further based at least in part on the measure of similarity between the corresponding larger-size variant and the impulse item.

9. The method of claim 1, wherein determining whether to recommend the corresponding larger-size variant to the customer comprises:
ranking the set of larger-size variants based at least in part on the recommendation score computed for the corresponding larger-size variant; and
determining whether to recommend the one or more larger-size variants to the customer based at least in part on the ranking.

10. The method of claim 9, wherein the set of larger-size variants is ranked among a set of content items maintained in the online concierge system.

11. A computer program product comprising a non-transitory computer-readable storage medium having instructions encoded thereon that, when executed by a processor, cause the processor to:
receive, at an online concierge system, information describing one or more items included in one or more orders placed by a customer of the online concierge system and a sequence of events included in a shopping session associated with each order of the one or more orders;
identify an impulse item from the one or more items based at least in part on one or more of: a set of impulse item identification rules, a set of item attributes of each item of the one or more items, and the sequence of events included in the shopping session associated with each order of the one or more orders;
access a first machine learning model trained to predict a measure of similarity between two items;
for each candidate item of a plurality of candidate items included among an inventory of a retailer associated with the online concierge system, apply the first machine learning model to the set of item attributes of the impulse item and the set of item attributes of a corresponding candidate item to predict the measure of similarity between the impulse item and the corresponding candidate item;
identify, from the plurality of candidate items, a set of larger-size variants of the impulse item based at least in part on the predicted measure of similarity between the impulse item and each candidate item of the plurality of candidate items, one or more item attributes of the impulse item, and the one or more item attributes of each candidate item;
access a second machine learning model trained to predict a likelihood that the customer will order an item;
for each larger-size variant of the set of larger-size variants:
apply the second machine learning model to the set of item attributes of a corresponding larger-size variant and a set of customer attributes of the customer to predict the likelihood that the customer will order the corresponding larger-size variant,
compute a recommendation score for the corresponding larger-size variant based at least in part on the predicted likelihood that the customer will order the corresponding larger-size variant, and
determine whether to recommend the corresponding larger-size variant to the customer based at least in part on the recommendation score for the corresponding larger-size variant;
generate a recommendation for one or more larger-size variants based at least in part on the determining; and
send the recommendation for display to a client device associated with the customer.

12. The computer program product of claim 11, wherein the sequence of events included in the shopping session associated with each order of the one or more orders describes one or more selected from the group consisting of: a time at which each of the one or more items was added to a shopping list, a time at which a request to check out for each of the one or more orders was received from a client device associated with the customer, a time at which a request to place each of the one or more orders was received from a client device associated with the customer, a portion of an ordering interface from which each of the one or more items was added to a shopping list, and a sequence in which the one or more items were added to a shopping list.

13. The computer program product of claim 11, wherein the set of item attributes comprises one or more selected from the group consisting of: a size of an item, one or more dimensions of an item, a volume of an item, a count associated with an item, a quantity of an item, one or more colors of an item, a weight of an item, a SKU of an item, a serial number of an item, a model of an item, a version of an item, a perishability of an item, a storage method associated with an item, a price of an item, an item category associated with an item, a brand of an item, a seasonality associated with an item, a sale associated with an item, a discount associated with an item, one or more qualities associated with an item, one or more ingredients of an item, one or more materials of an item, and one or more manufacturing locations for an item.

14. The computer program product of claim 11, wherein the recommendation for the one or more larger-size variants comprises a unit price associated with each larger-size variant of the one or more larger-size variants and the impulse item and the recommendation for the one or more larger-size variants calls attention to the unit price associated with each larger-size variant of the one or more larger-size variants.

15. The computer program product of claim 11, wherein the measure of similarity between the impulse item and the corresponding candidate item is predicted based at least in part on a set of item embeddings.

16. The computer program product of claim 11, wherein compute the recommendation score for the corresponding larger-size variant is further based at least in part on a value associated with the corresponding larger-size variant.

17. The computer program product of claim 11, wherein apply the second machine learning model further comprises:
apply the second machine learning model to a current set of contextual and seasonal features, wherein the current set of contextual and seasonal features comprises one or more selected from the group consisting of: a time of day, a day of a week, one or more seasons, one or more shopping periods, and one or more holidays.

18. The computer program product of claim 11, wherein compute the recommendation score for the corresponding larger-size variant is further based at least in part on the measure of similarity between the corresponding larger-size variant and the impulse item.

19. The computer program product of claim 11, wherein determine whether to recommend the corresponding larger-size variant to the customer comprises:
rank the set of larger-size variants based at least in part on the recommendation score computed for the corresponding larger-size variant; and
determine whether to recommend the one or more larger-size variants to the customer based at least in part on the ranking.

20. A computer system comprising:
a processor; and
a non-transitory computer-readable storage medium storing instructions that, when executed by the processor, perform actions comprising:
receiving, at an online concierge system, information describing one or more items included in one or more orders placed by a customer of the online concierge system and a sequence of events included in a shopping session associated with each order of the one or more orders;
identifying an impulse item from the one or more items based at least in part on one or more of: a set of impulse item identification rules, a set of item attributes of each item of the one or more items, and the sequence of events included in the shopping session associated with each order of the one or more orders;
accessing a first machine learning model trained to predict a measure of similarity between two items;
for each candidate item of a plurality of candidate items included among an inventory of a retailer associated with the online concierge system, applying the first machine learning model to the set of item attributes of the impulse item and the set of item attributes of a corresponding candidate item to predict the measure of similarity between the impulse item and the corresponding candidate item;
identifying, from the plurality of candidate items, a set of larger-size variants of the impulse item based at least in part on the predicted measure of similarity between the impulse item and each candidate item of the plurality of candidate items, one or more item attributes of the impulse item, and the one or more item attributes of each candidate item;
accessing a second machine learning model trained to predict a likelihood that the customer will order an item;
for each larger-size variant of the set of larger-size variants:
applying the second machine learning model to the set of item attributes of a corresponding larger-size variant and a set of customer attributes of the customer to predict the likelihood that the customer will order the corresponding larger-size variant,
computing a recommendation score for the corresponding larger-size variant based at least in part on the predicted likelihood that the customer will order the corresponding larger-size variant, and
determining whether to recommend the corresponding larger-size variant to the customer based at least in part on the recommendation score for the corresponding larger-size variant;
generating a recommendation for one or more larger-size variants based at least in part on the determining; and
sending the recommendation for display to a client device associated with the customer.
